(19) United States
(12) Patent Application Publication
(10) Pub. No.: US 2021/0079706 A1
(43) Pub. Date: Mar. 18, 2021

(54) SPRING ASSEMBLY FOR A FLAP HOLDER

(71) Applicant: Samet Kalip Ve Maden Esya San. Ve Tic. A.S., Istanbul (TR)

(72) Inventor: Artur HIRTSIEFER, Neunkirchen-Seelscheid (DE)

(21) Appl. No.: 16/613,170

(22) PCT Filed: May 15, 2017
(86) PCT No.: PCT/TR2017/000056

§ 371 Date: Nov. 13, 2019

(51) Int. Cl. E05F 5/08

(52) U.S. Cl. CPC E05F 5/08; E05Y 2201/474; E05Y 2201/246; E05Y 2201/218

(57) ABSTRACT

The invention relates to a spring assembly for driving a flap holder for a flap of an item of furniture, wherein the spring assembly has a first and a second holder, wherein the holders are pretensioned against one another by means of at least one spring, and wherein each holder comprises at least one spring support. Good lateral guiding of the springs disposed in such a spring assembly can be achieved in that the holders are pretensioned against one another by at least two springs disposed in series with one another, and that a coupling is disposed between the springs and transmits the force between the springs disposed in series with one another and comprises at least two spring guides laterally guiding the springs at least in sections.

The invention relates to a spring assembly for driving a flap holder for a flap of an item of furniture, wherein the spring assembly has a first and a second holder, wherein the holders are pretensioned against one another by means of at least one spring, and wherein each holder comprises at least one spring support.

A flap holder having such a spring assembly is known from DE 10 2015 117 B3. Flap holders of this type are used for supporting the opening and closing motion of a flap on an item of furniture. The flap can thereby be implemented as a single-part or double-part folding flap. The flap holder is hinged to the flap by means of a control arm and thereby transmits the force acting in an opening direction on the flap. The energy required is provided by an energy store implemented as a spring assembly. The energy store comprises two holders disposed opposite one another and pretensioned against one another by means of tension elements. The ends of the tension elements implemented as compression springs are thereby each inserted in spring supports of the holders. One holder is hinged to a housing of the flap holder by means of a pivot bearing. The opposite holder is hinged to a lever mechanism by means of a coupling link. The lever mechanism transmits the spring force to a lever for attaching to the control arm leading to the flap.

The compression springs are designed for providing a comparatively high pretension between the two holders. To this end, the springs are not externally guided in the region between the two holders. Guiding by means of a spring mandrel disposed in the core of the compression springs is possible only to a limited degree, as the spring mandrel limits the displacement path of the two holders with one another. This presents a risk that the compression springs would buckle laterally in the region between the holders. This is particularly true for positions of the flap holder in which the two holders of the spring assembly are disposed far apart from one another.

It is therefore the object of the invention to provide a spring assembly enabling secure guiding of the springs used over the entire intended displacement path of the spring assembly.

The object of the invention is achieved in that the holders are pretensioned against one another by means of at least two springs disposed in series relative to one another, and that a coupling is disposed between the springs and transmits the force between the springs disposed in series and comprises at least two spring guides laterally guiding the springs at least in sections. Guiding the springs reliably prevents lateral buckling of the springs. The ends of the springs opposite the coupling are received in the spring supports of the holders disposed opposite one another. Said springs are thereby also laterally guided in the end regions thereof facing away from the coupling. The coupling is held in the direction of the acting spring force only by the springs disposed in series with one another. The coupling is thus positioned in a self-centering manner in the displacement direction of the spring assembly. The coupling remains disposed in the gap implemented between the holders in all permissible positions of the two holders with one another. Lateral guiding of the springs is thereby ensured over the entire permissible displacement range.

Good lateral guiding of the springs by the coupling can be achieved in that at least one of the spring guides is implemented as a sleeve into which the associated spring is at least partially inserted, and/or that at least one of the spring guides is implemented as a mandrel onto which the associated spring is at least partially placed.

According to a particularly preferred embodiment variant of the invention, it can be provided that the coupling comprises at least one spring stop against which the springs make contact opposite the holder associated with the corresponding spring. The spring force is transmitted between the springs by means of the spring stop. At the same time, the coupling is held by the spring stop clamped between the springs.

The lateral guiding of the springs can be further improved in that at least one spring guide is implemented as a sleeve, and that the associated spring is guided by at least one additional spring mandrel and/or that the at least one spring guide is implemented as a mandrel and that the associated spring is guided at least in sections by the spring support of a holder and/or by an additional spring sleeve. In this manner, the springs are guided both at the inner diameter and at the outer diameter thereof. The additional guide elements (spring mandrel or spring sleeve) advantageously support the springs starting from the end regions opposite the spring guides of the coupling. The present embodiment variant of the invention achieves that the springs are supported transverse to the longitudinal extent thereof and along the entire length thereof for all permissible positions of the spring assembly.

Simple construction of the spring assembly and simultaneous good lateral guiding of each spring can be achieved in that the spring mandrel is inserted into the spring from the holder side, that the spring mandrel is supported on the holder, and that the spring makes contact with a flange of the spring mandrel. The spring is thus guided on one side by the spring mandrel and on the opposite side by the spring guide of the coupling. The guide regions can thereby intersect in an overlapping region depending on the present compression and thus the length of the springs.

Reliable lateral guiding of the coupling can be achieved in that the spring guide is disposed in a spring support of a holder at least in sections. The spring guide of the coupling is thus laterally supported directly or indirectly on the spring support of the holder.

It can be particularly preferably provided that the coupling is implemented as a tube having an interior space divided by the first spring stop into two sleeve sections forming the spring guides, of which the one is open toward the first holder and the other one is open toward the second holder. In this manner, simple construction of the coupling and simultaneously good lateral guiding of the springs disposed opposite and inserted into the sleeve sections can be achieved. The first spring stop forms the inner closure of the spring guides implemented as sleeves, against which the springs make contact on both sides.

Simple construction of the coupling and simultaneously good lateral guiding of the springs can further be achieved in that the coupling is implemented as a rod on which the second spring stop is formed as a region having an enlarged cross section in comparison with the rod, and that the second spring stop divides the rod into two mandrels forming the spring guides, of which one is aligned facing the direction toward the first holder and the other is aligned facing the second holder. The springs can thus be placed on the mandrels and are laterally guided thereby. The ends thereby make contact opposite at the second spring stop, whereby the coupling is held between the springs and the springs are connected in series with one another.

According to the invention, it can be provided that the spring stop is disposed in the center of the coupling or outside the center and spaced apart from the ends of the coupling, relative to the longitudinal extent of the coupling. An arrangement of the spring stop in the center of the coupling is advantageous if the springs connected in series are identical in design and the depth of the spring supports oppositely deposed in the holders is selected to be identical. For an asymmetrical construction, wherein differently implemented springs are used and/or spring support having different depths from one another are provided in one spring line, an arrangement of the spring stop outside of the center of the coupling can be advantageous for ensuring that the gap implemented between the holders is completely bridged by the coupling.

In order to achieve a greater spring force acting between the holders, it can be provided that the holders are pretensioned against each other by means of at least one further, continuous spring element. The spring element thus acts in parallel with the springs disposed in series with one another. The coupling is self-centered here due to the support thereof between the springs disposed in series with one another.

Lateral buckling of the continuous spring element disposed between the holders can eb prevented in that the continuous spring element is guided by the coupling at least in sections and/or that the continuous spring element is held in the opposite spring supports of the opposite holders at least in sections. If the spring guide of the coupling is implemented as a sleeve, then the continuous spring element can be externally guided on the coupling. The outer surface of the coupling then forms a guide surface for the continuous spring element. For a coupling implemented as a rod, the continuous spring element can be put over the springs place on the spring guides. A hole can also be made in the coupling running along the center longitudinal axis, in which the continuous spring element is disposed.

The energy stored in the spring assembly and the available spring force can be adapted to the particular requirements in that at least two spring lines acting in parallel with one another and each having a coupling and each having at least two springs (83, 91) disposed in series with one another are disposed between the holders and pretension the holders against one another.

The invention is described in greater detail below using an embodiment example shown in the drawings. They show:

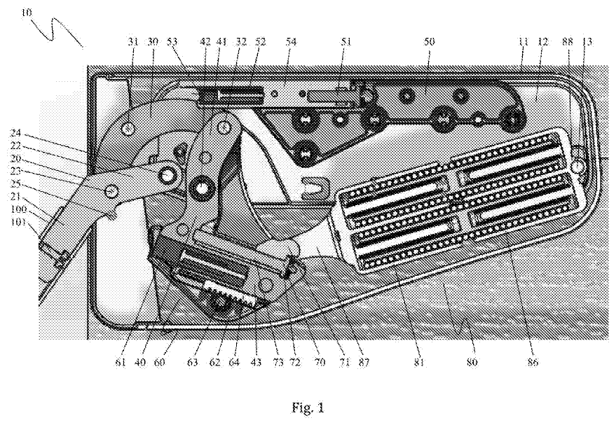

FIG. 1 A side view of a flap holder for a furniture flap having a first spring assembly,

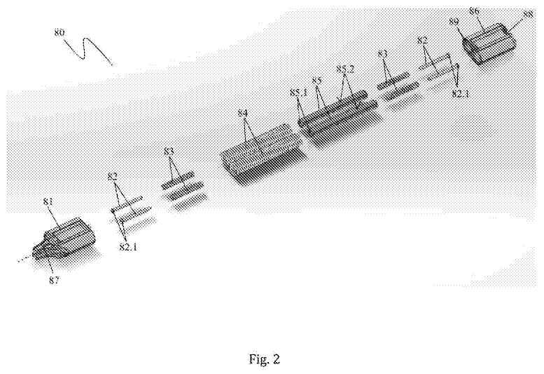

FIG. 2 A perspective exploded view of the first spring assembly shown in FIG. 1,

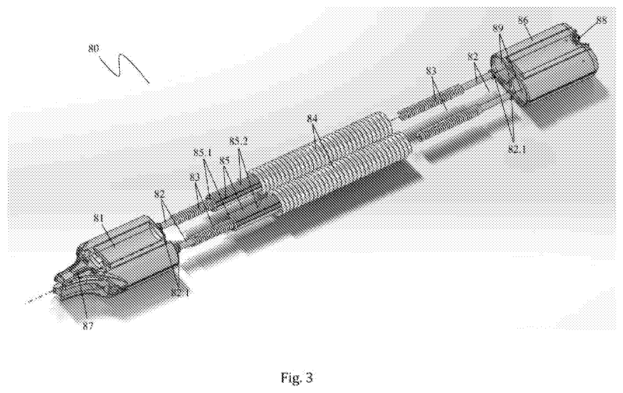

FIG. 3 The first spring assembly shown in FIG. 2 with components partially inserted in one another,

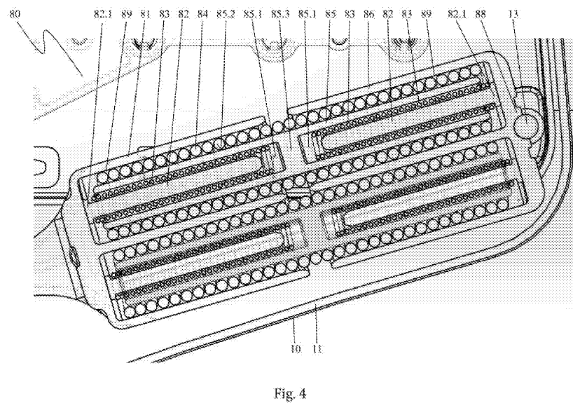

FIG. 4 A magnified side section view of the first spring assembly shown in FIG. 1, and

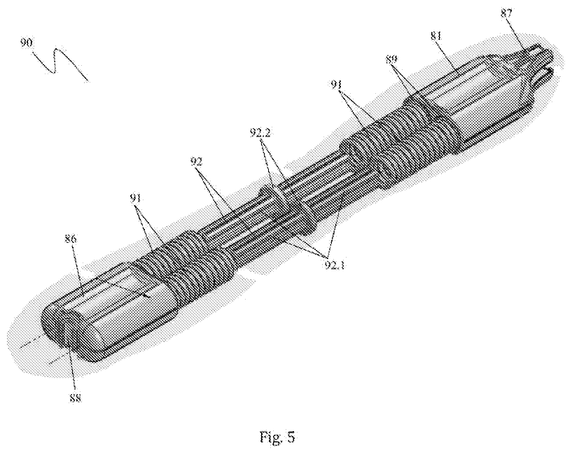

FIG. 5 A perspective exploded view of a second spring assembly.

FIG. 1 shows a side view of a flap holder 10 for a furniture flap having a first spring assembly 80. The flap holder 10 is enclosed in a housing 11. Said holder comprises two bearing plates 12 disposed spaced apart from one another by means of a spacer 50, of which only one can be seen in the selected section view.

A lever shoulder 21 of a lever 20 leads out of the housing 11. The lever 20 is part of a lever mechanism. The lever mechanism transmits a spring force provided by the present first spring assembly 80 to a control arm 100 placed on the lever shoulder 21 of the lever 20 and fixed thereon by means of an attachment screw 101. The control arm 100 forms an articulated connection to a flap, folding flap, door, or the like of an item of furniture on the body of which the flap holder is attached. The lever 20 comprises a mounting segment 22. Said segment is hinged to the two bearing plates 12 by means of a pivot axis 24. A coupling point 23 is formed on each side of the lever 20. Said point serves as an articulated connection of the lever 20 to the connecting segments 30 leading to the lever 20, of which only the rear one is visible in the selected section view. The connecting segments 30 are implemented having an arc shape. Said segments are hinged to a tensioning lever 40 opposite the lever 20 by means of a second coupling point 32.

The tensioning lever 40 is pivotally connected to the bearing plates 12 by a bearing 42. The connection to the connecting segment 30 is thereby made at a lever arm 41 of the tensioning lever 40 extending from the bearing 42. The tensioning lever 40 implements a shoulder 43 opposite the lever arm 41. A slider 62 is linearly displaceably supported on the shoulder 43. The slider 62 is part of a damping unit 60. A damper 61 having a control element 63 and a gear rack 64 are associated with the damping unit 60. The slider 62 interacts with a stop 25 formed on the lever 20 and facing the slider 62. When closing the furniture flap, the stop 25 and the slider 62 collide, whereby the slider 62 is displaced. The slider 62 compresses the damper 61, whereby the closing motion is damped. The damping range of the damping unit 60 can be adjusted by means of the gear rack 64.

An actuating element 70 is further disposed on the shoulder 43 of the tensioning lever 40. The actuating element 70 comprises a control part 72 and a thread 73 connected thereto. The actuating element 70 is rotatably, but linearly fixedly, connected to the shoulder 43 of the tensioning lever 40. A bearing piece 71 is screwed onto the thread 73. By rotating the actuating element 70, the bearing piece 71 can be continuously variably adjusted along the thread 72. The first spring assembly 80 is coupled to the bearing piece 71. The first spring assembly 80 comprises a first holder 81 and a second holder 86 spaced apart therefrom. The two holders 81, 86 are pretensioned against one another by means of tension elements, as is shown in greater detail in FIGS. 1 through 4. Here the tension elements are disposed in two spring lines acting in parallel with one another, each tensioned between the two holders 81, 86. A coupling link 87 is formed on the first holder 81 and produces the pivotal and releasable connection to the bearing piece 71. The second holder 86 is pivotally supported on a bearing stud 13 on the opposite side by means of a bearing segment 88 formed thereon The bearing stud 13 is fixed to the two bearing plates 12.

The first spring assembly 80 is thus tensioned between the bearing stud 13 and the bearing piece 71. The tension elements thereby exert a force on the holders 81, 86 and presses the same apart. The force is transmitted to the tensioning lever 40 by means of the bearing piece 71. The tensioning lever 40 transmits the force to the lever 20 and the control arm connected thereto by means of the connecting segments 30. Said control arm in turn transmits the force to the connected flap, folding flap, door, or the like.

The position of the bearing piece 71 can be modified by means of the actuating element 70. The lever length between the force applied by the first spring assembly 80 and the bearing 42 of the tensioning lever 40 is thus modified. The force applied to the lever 20 can thus be adjusted by means of the actuating element 70 and thus adapted to the weight of the flap, folding flap, door, or the like being used.

A sliding piece 54 is disposed on the spacer 50 and supports a damping element 52. The position of the sliding piece 54 and thus of the damping element 52 can be adjusted relative to the spacer 50 by means of the adjusting element 51. A contact point 53 of the damping element 52 is disposed in the displacement path of a fixing element 31 connecting the connecting segments 30. When opening the furniture flap, the fixing element 31 strikes the contact point 53 of the damping element 52, whereby the opening motion is damped in the last motion segment thereof. The damping region can be adjusted by means of the adjusting element 51.

FIG. 2 shows a perspective exploded view of the first spring assembly 80 shown in FIG. 1 in the installed position on the flap holder 10. Starting from the first holder 81, disposed in two adjacent spring lines, are a spring mandrel 82, an inner spring 83, a spring element 84, a first coupling 85, a further inner spring 83, and a spring mandrel 82. The components are aligned with one another along the longitudinal extents thereof within the spring lines. Two spring supports 89 are formed in the holders 81, 86 and are open toward the opposite holder 81, 86. The rows of components are aligned with the two spring supports 89 opposite one another.

The spring mandrels 82 are closed by means of a flange 82.1 at the ends thereof facing toward the holders 81, 86. First spring guides 85.1 running along the longitudinal extent thereof are made in the first couplings 85. The spring guides 85.1 are implemented as sleeves. The outer surfaces of the first couplings 85 form guide surfaces 85.2.

FIG. 3 shows the first spring assembly 80 shown in FIG. 2 with components partially inserted in one another. The inner springs 83 are placed slightly over the spring mandrels 82. The inner springs 83 facing toward the first holder 81 are partially inserted in the first spring guides 85.1 of the first couplings, each disposed in a spring line. The inner springs 83 are thus guided internally by the spring mandrels 82 and externally by the couplings 85. The spring elements 84 are partially placed on the first spring guides 85.1. The spring elements 84 are guided by the couplings 85 in this manner.

FIG. 4 shows a magnified side section view of the first spring assembly 80 shown in FIG. 1. The first spring assembly 80 is installed in the flap holder 10 according to the depiction in FIG. 1. The holders 81, 86 are aligned with one another such that two spring supports 89 each face one another. One spring line each is disposed between the opposite spring supports 89. The two spring lines are constructed identically. The following description therefore is made for one spring line, but relates to both spring lines.

The first coupling 85 is implemented as a tube. The interior space of the coupling 85 is divided into the two first spring guides 85.1 by a first spring stop 85.3. The spring guides 85.1 are implemented as sleeves. Said guides are each open toward one holder 81, 86.

A spring mandrel 82 is disposed in each of the spring supports 89. The spring mandrels 82 are supported by the flanges thereof 82.1 on the inner closures of the spring supports 89. The inner springs 83 are placed on the spring mandrels 82 and contact the flanges 82.1 thereof. The first spring guides 85.1 of the first coupling 85 are put over the inner springs 83. Each spring guide 85.1 is guided into the opposite spring support 89 of the opposite holder 81, 86. The inner springs 83 are thus tensioned between the flanges 82.1 of the spring mandrels 82 and the first spring stop 85.3 of the first coupling 85. The spring element 84 is placed on the outer guide surface 85.2 of the first coupling 85. Said element is guided into the opposite spring supports 89 on both sides. Said element is thereby disposed within each spring support 89 between the first coupling 85 and the wall of the spring support 89. The spring element 84 is supported in the longitudinal direction on the floor of the corresponding spring support 89.

As shown in FIG. 1, the first spring assembly 80 is tensioned between the bearing piece 71 of the actuating element 70 and the bearing stud 13. The inner springs 83 implemented as compression springs and spring elements 84 are thereby compressed. The holders 81, 86 are spaced apart from one another by a gap.

As can be seen in FIG. 4, the pretensioned spring elements 84 are supported on the holders 81, 86 disposed opposite one another and press the same apart. The inner springs 83 of a spring line are connected with one another in series by means of the first coupling 85. Said springs also thus transmit a force acting outwardly to the opposite holder 81, 86. The holders 81, 86 are thus pretensioned against each other by both the spring elements 84 and the inner springs 83.

The inner springs 83 of a spring line are supported at the first spring stop 85.3 of the associated first coupling 85. The inner springs 83 within a spring line are identical in design and have the same spring constant. The first coupling 85.3 is thus aligned for self-centering between the two holders 81, 86. When the distance between the two holders 81, 86 changes, the position of the first coupling 85.3 changes in the same manner relative to the two holders 81, 86. The first coupling 85.3 is thus always positioned so as to bridge the gap implemented between the holders 81, 86 within the permissible actuating path of the two holders 81, 86 with one another. The spring element 84 externally guided on the first coupling 85.3 is thereby always supported by the first coupling 85.3 in the region of the gap between the holders 81, 86. Lateral buckling of the spring elements 84 is thus securely prevented in all potential positions of the two holders 81, 86 relative to each other within the displacement range of the first spring assembly 80. This applies particularly when the first spring assembly is relaxed or largely relaxed, wherein the holders 81, 86 are spaced apart from one another the furthest within the potential displacement range. The spring supports 89 and the first coupling 85 are mutually tuned so that the first coupling 85 still protrudes into the corresponding spring supports 89 by a defined length even at the greatest permissible distance between the holders 81, 86. Secure lateral guiding of the first coupling 85 and the holders 81, 86 relative to one another is thereby achieved.

The spring elements 84 are laterally supported by the walls of the spring supports 89 within the spring supports 89. Lateral buckling of the spring elements 84 is also prevented in this region as well.

The inner springs 83 are guided internally by the spring mandrels 82 and externally in the first spring guides 85.1 of each first coupling 85. The lengths of the first spring guide 85.1 and the spring mandrels 82 are mutually tuned so that the spring mandrels 82 protrude into each spring guide 85.1 of the associated first coupling 85 by a defined distance, even at the greatest permissible distance between the holders 81, 86. Continuous lateral guiding of the inner springs 83 is thereby achieved.

FIG. 5 shows a perspective exploded view of a second spring assembly 90. The second spring assembly 90 comprises the same holders 81, 86 as the first spring assembly 90 shown in FIGS. 1 through 4, and reference is made to the description thereof. The outer dimensions of the two assembled spring assemblies 80, 90 are identical, so that said assemblies can be equivalently installed in the flap holder 10 shown in FIG. 1.

The second spring assembly 90 also comprises two spring lines deposed parallel to one another. Starting from the first holder 81, each spring line has a spring 91, a second coupling 92, and a further spring 91 aligned with one another. The springs 91 are implemented as a compression spring. Said springs are each associated with a spring support 89 of the holder 81, 86 disposed on the opposite side. The outer diameter thereof is selected so that said springs can be placed in the spring supports 89 at a short distance from the walls thereof.

The second couplings 92 are implemented as bars. Said couplings have a substantially square cross section, wherein guide segments are formed along the corners of the coupling 92 running in the longitudinal direction. The distance of the outer surfaces of the guide segments disposed diagonally opposite is slightly less than the inner diameter of the springs 91. Second spring guide 92.1 are thus implemented, onto which the springs 91 can be placed. It is also conceivable to use second couplings 92 having cylindrical second spring guides 92.1.

Each second coupling 92 comprises a second spring stop 92.2 by means of which said coupling is divided into two second spring guides 92.1 each. The second spring stop 92.2 is implemented having a washer shape. Said stop has a greater diameter than the second spring guides 92.1. Here the second spring stop 92.2 is disposed in the center of the second coupling 92 in the longitudinal direction. It is also conceivable, however, to dispose the second spring stop 92.2 outside of the center. This is advantageous, for example, if the springs 91 disposed within a spring line are not identical in design, and/or if the spring supports 89 of the holders 81, 86 disposed opposite one another are not identical in design.

For installing, the springs 91 are placed onto the associated second spring guides 92.1 of the second coupling 92. The springs 91 are then inserted into the associated spring supports 89 with the second spring guides 92.1. The second spring assembly 90 can now be placed in the flap holder 10 according to the depiction in FIG. 1, wherein the two holders 81, 86 are pretensioned relative to one another.

In the assembled state, the springs 91 contact the floors facing away from the openings thereof in the interior of the spring supports 89. On the opposite side, the springs 91 strike the second spring stops 92.2 of the couplings 92. The springs 91 are guided at the inner diameter thereof in sections by the second spring guides 92.1. The springs 91 are guided externally by the spring supports 89 on the opposite side. The second spring guides 92.1 thereby extend into the corresponding spring supports 89 by a defined distance in every permissible displacement position of the second spring assembly 90. The springs 91 are thus laterally guided over the entire length thereof. The guiding thereby is done by the second spring guides 92.1 of the couplings 92 outside of the spring supports 89. Within the spring guides 92.1, the springs 91 are guided by the walls of the spring supports 89 and additionally in sections by the spring guides 92.1 of the couplings 92. It is thereby securely prevented that the springs 91 buckle laterally.

The springs 91 of a spring line are disposed in series. The second coupling 92 thus transmits the spring force between the springs 91.

The springs 91 contacting the second spring stops 92.2 on both sides thereby center the position of the second coupling 92 automatically. The second couplings 92 are thus always disposed between the holders 81, 86 relative to one another within the permissible displacement path of the holders 81, 86. The lengths of the two spring guides 92.1, the depths of the spring supports 89, and the maximum permissible displacement path of the second spring assembly 90 are thereby mutually tuned such that the end regions of the second couplings 92 always protrude into the associated spring supports 89 by a defined distance.

For both the first and the second spring assembly 80, 90, the springs 83, 91 and spring elements 84 are disposed along two spring lines acting in parallel with one another. It is also conceivable, however, to provide spring assemblies 80, 90 having only one spring line or having more than two spring lines. It is further conceivable that more than two springs 83, 91 act on one coupling 85, 92. A substantial idea of the invention is that the coupling 85, 92 is longitudinally displaceably held between springs 83, 91 disposed in series with one another.

1-12. (canceled)

13. A spring assembly for driving a door holder for a door of a piece of furniture, the spring assembly comprising:
a first bracket;
a second bracket;
at least two springs disposed in series with one another between the first and second brackets to bias the first and second brackets away from each other; and
a coupling piece disposed between the at least two springs to transmit force between the at least two springs, the coupling piece including at least two spring guides configured to laterally guide at least portions of the at least two springs.

14. The spring assembly of claim 13, wherein:
at least one of the spring guides includes a sleeve and an associated one of the springs is at least partially inserted into the sleeve.

15. The spring assembly of claim 13, wherein:
at least one of the spring guides includes a mandrel and an associated one of the springs is at least partially placed onto the mandrel.

16. The spring assembly of claim 13, wherein:
the coupling piece includes at least one spring stop, and an end of each of the springs opposite an associated one of the brackets bears against the at least one spring stop.

17. The spring assembly of claim 13, wherein:
at least one of the spring guides includes a sleeve and an associated one of the springs is at least partially inserted into the sleeve; and
the spring assembly further includes at least one spring mandrel received in the associated one of the springs for further guiding the associated one of the springs.

18. The spring assembly of claim 17, wherein:
the at least one spring mandrel is inserted into an end of the associated one of the springs facing an associated one of the brackets, the spring mandrel being supported on the associated one of the brackets, and the associated one of the springs bears against a flange of the spring mandrel.

19. The spring assembly of claim 13, wherein:
at least one of the spring guides includes a mandrel and an associated one of the springs is at least partially placed onto the mandrel; and
at least one of the brackets includes a spring receptacle and the associated one of the springs is at least partially received in and guided by the spring receptacle.

20. The spring assembly of claim 13, wherein:
at least one of the brackets includes a spring receptacle defining at least one of the spring guides at least in part.

21. The spring assembly of claim 13, wherein:
the coupling piece includes a tube including an interior space divided by a first spring stop into two sleeve sections forming the at least two spring guides, one of the sleeve sections being open toward the first bracket and the other of the sleeve sections being open toward the second bracket.

22. The spring assembly of claim 13, wherein:
the coupling piece includes a rod including an enlarged cross-section portion defining a spring stop, the spring stop dividing the rod into two mandrels forming the at least two spring guides, one of the mandrels facing toward the first bracket and the other of the mandrels facing toward the second bracket.

23. The spring assembly of claim 13, wherein:
the coupling piece includes first and second ends and at least one spring stop spaced from the first and second ends, and an end of each of the springs opposite an associated one of the brackets bears against the at least one spring stop.

24. The spring assembly of claim 23, wherein:
the spring stop is disposed at a center of the coupling piece relative to a length of the coupling piece.

25. The spring assembly of claim 13, further comprising:
at least one further continuous spring element between the first and second brackets to further bias the first and second brackets away from each other.

26. The spring assembly of claim 25, wherein:
the continuous spring element is at least partially guided by the coupling piece.

27. The spring assembly of claim 25, wherein:
the continuous spring element is at least partially received in spring receptacles defined in the first and second brackets.

28. The spring assembly of claim 13, further comprising:
another at least two springs disposed in series with one another between the first and second brackets, the another at least two springs acting in parallel with the first mentioned at least two springs; and
another coupling piece disposed between the another at least two springs to transmit force between the another at least two springs.
